(19) United States
(12) Patent Application Publication
(10) Pub. No.: US 2022/0254521 A1
(43) Pub. Date: Aug. 11, 2022

(54) ENCRYPTION PROTECTED PLASMA COMPRESSION FUSION DEVICE

(71) Applicant: Qwyit, LLC, Vienna, VA (US)

(72) Inventor: Michael Patrick Fortkort, Great Falls, VA (US)

(73) Assignee: Qwyit,LLC, Vienna, VA (US)

(21) Appl. No.: 17/590,958

(22) Filed: Feb. 2, 2022

Related U.S. Application Data
(60) Provisional application No. 63/146,772, filed on Feb. 8, 2021.

(51) Int. Cl. G21B 1/05; H04B 1/7075; G21B 1/21; G21B 1/17

(52) U.S. Cl. CPC G21B 1/05; H04B 1/7075; H04L 63/0428; G21B 1/17; G21B 1/21

(57) ABSTRACT

In a plasma compression fusion device, two electrical grids used to ionize the Deuterium gas (or other fusion fuel in gaseous form). The two grids are kept at different oppositely charged voltages so as to electrostatically accelerate either electrons or ions into the plasma core, depending on desired physical effect. Each of the grids are driven by an electrical signal—one positive and one negative. The two signals are controlled by a spread spectrum modulator that outputs the desired electrical signal, which is modulated by the spread spectrum modulator under the control of a pseudo random (PN) sequence. To achieve the desired electrical effect, the two signals must be matched exactly in phase and amplitude. One signal, e.g., the positive signal, is controlled by a PN sequence from outside the device, whereas the opposite signal is controlled by a PN sequence built into the device. If the two PN sequences are identical, then both of the desired electrical signals are created having the same amplitude and phase, in which case the fusion device will operate as designed. If the two sequences do not match, the two plates will not create the proper ionization of the Deuterium gas, rendering the device inoperable for its intended purpose. The enables control of the device from outside since the two PN sequences must match to operate.

### RELATED APPLICATIONS

The present invention claims the benefit of U.S. Provisional Patent Application No. 63/146,772 filed by the same inventor bearing the same title on Feb. 8, 2021, which provisional application is hereby incorporated by reference as if repeated herein in its entirety.

### BACKGROUND

The present invention relates generally to plasma compression fusion devices, and more particularly to a plasma compression fusion device using magnetic fields to confine the plasma core.

U.S. Patent Publication No. 2019/0295733 by Salvatore Pais discloses a plasma compression fusion device, which publication is hereby incorporated by reference as if repeated herein in its entirety, including the drawings. Such devices have significant potential for causing environmental damage as well as damage to human life.

The present invention is therefore directed to the problem of developing a method for protecting a plasma compression fusion device.

### SUMMARY OF THE INVENTION

The present invention provides two electrical grids used to ionize the Deuterium gas (or other fusion fuel in gaseous form). The two grids are kept at different oppositely charged voltages so as to electrostatically accelerate either electrons or ions into the plasma core, depending on desired physical effect. Each of the grids are driven by an electrical signal—one positive and one negative. The two signals are controlled by a spread spectrum modulator that outputs the desired electrical signal, which is modulated by the spread spectrum modulator under the control of a pseudo random (PN) sequence. To achieve the desired electrical effect, the two signals must be matched exactly in phase and amplitude. One signal, e.g., the positive signal, is controlled by a PN sequence from outside the device, whereas the opposite signal is controlled by a PN sequence built into the device. If the two PN sequences are identical, then both of the desired electrical signals are created having the same amplitude and phase, in which case the fusion device will operate as designed. If the two sequences do not match, the two plates will not create the proper ionization of the Deuterium gas, rendering the device inoperable for its intended purpose. The enables control of the device from outside since the two PN sequences must match to operate.

According to another aspect of the present invention, a plasma compression fusion device includes a hollow linear-duct having a vacuum chamber disposed within the hollow linear-duct. One pair of opposing, smoothly curved-headed, counter-spinning conical structures are disposed within the hollow linear-duct. Each counter-spinning conical structure has a plurality of orifices and an outer surface which is electrically charged, and in combination the pair create a concentrated magnetic energy flux and electromagnetic radiation within the vacuum chamber, whereby the concentrated magnetic energy flux compresses a mixture of gases that are injected through the orifices to the vacuum chamber such that a plasma core is created. The electromagnetic radiation heats the plasma core, while produced magnetic fields confine the plasma core between the counter-spinning conical structures, such that when an additional mixture of gases is introduced into the plasma core through the orifices, an energy gain is created. A first spread spectrum modulator receives a first pseudorandom sequence and is coupled to the electrically charged outer surface and drives the outer surface with a first electrical signal. A second spread spectrum modulator receives a second pseudorandom sequence and is coupled to the plurality of orifices and drives the plurality of orifices with a second electrical signal being electrically negative with respect to the first electrical signal. A voltage source is coupled to each of the first and second modulators, whereby if the first pseudorandom signal matches the second pseudorandom signal, said first electrical signal matches said second electrical signal in phase and amplitude but with opposite charge, thereby enabling said energy gain to be created only if the two pseudorandom sequences match.

According to yet another aspect of the present invention, a plasma compression fusion device includes a hollow cross-duct having a vacuum chamber disposed within the hollow cross-duct. At least two pairs of opposing, smoothly curved-headed, counter-spinning conical structures are disposed within the hollow cross-duct. Each counter-spinning conical structure has a plurality of orifices and an outer surface which is electrically charged, and in combination all the pairs create a concentrated magnetic energy flux and electromagnetic radiation within the vacuum chamber, whereby the concentrated magnetic energy flux compresses a mixture of gases that are injected through the orifices the vacuum chamber such that a plasma core is created, and the electromagnetic radiation heats the plasma core, while produced magnetic fields confine the plasma core between the counter-spinning conical structures, such that when an additional mixture of gases is introduced into the plasma core through the orifices, an energy gain is created. A first spread spectrum modulator receives a first pseudorandom sequence and is coupled to the electrically charged outer surface and driving the outer surface with a first electrical signal. A second spread spectrum modulator receives a second pseudorandom sequence and is coupled to the plurality of orifices and drives the plurality of orifices with a second electrical signal that is electrically negative with respect to the first electrical signal. A voltage source is coupled to each of the first and second modulators, whereby if the first pseudorandom signal matches the second pseudorandom signal, said first electrical signal matches said second electrical signal in phase and amplitude but with opposite charge, thereby enabling said energy gain to be created only if the two pseudorandom sequences match.

According to still another aspect of the present invention, a plasma compression fusion device includes a hollow cross-duct having a vacuum chamber disposed within the hollow cross-duct. At least two pairs of conical frustums are disposed within the hollow cross-duct. Each conical frustum has a plurality of orifices and an outer surface which is electrically charged, and in combination all the pairs create a concentrated magnetic energy flux and electromagnetic radiation within the vacuum chamber, whereby the concentrated magnetic energy flux compresses a mixture of gases that are injected through the orifices to the vacuum chamber such that a plasma core created, and the electromagnetic radiation heats the plasma core, while produced magnetic fields confine the plasma core between conical frustums, such that when an additional mixture of gases is introduced into the plasma core through the orifices, an energy gain is created. A first spread spectrum modulator receives a first pseudorandom sequence and is coupled to the electrically charged outer surface and drives the outer surface with a first electrical signal. A second spread spectrum modulator receives a second pseudorandom sequence and is coupled to the plurality of orifices and drives the plurality of orifices with a second electrical signal being electrically negative with respect to the first electrical signal. A voltage source is coupled to each of the first and second modulators, whereby if the first pseudorandom signal matches the second pseudorandom signal, the first electrical signal matches the second electrical signal in phase and amplitude but with opposite charge, thereby enabling said energy gain to be created only if the two pseudorandom sequences match.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 depicts an encrypted compression fusion device according to one aspect of the present invention.

FIGS. 2-3 depict prior art compression fusion devices.

### DETAILED DESCRIPTION

U.S. Patent Publication No. 2019/0295733 discloses a compression fusion device, which is hereby incorporated by reference, as if repeated herein in its entirety including the drawings. The present invention provides a mechanism for securing the device from operating without the proper encryption key, which is a pseudo random sequence.

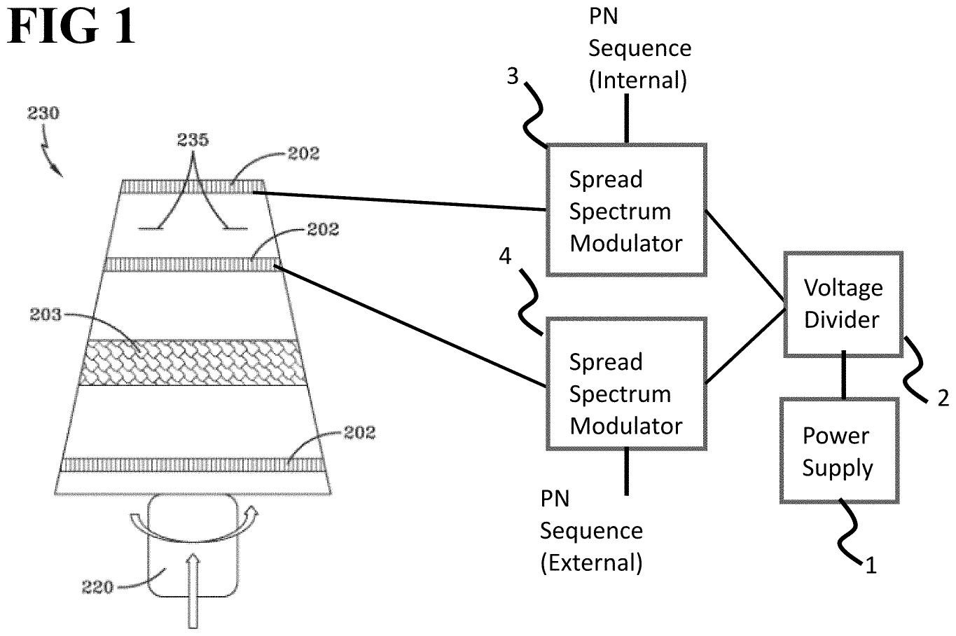

Turning to FIG. 1, shown there is the compression fusion device of the present invention. The plasma compression fusion device 10 may include only one pair of two opposing curved-headed counter-spinning conical structures 200 disposed in a linear configuration within a hollow linear-duct 150.

A power supply 1 coupled to a voltage divider 2 drives two separate spread spectrum modulators, each of which are controlled by PN sequences, one externally provided and one internally provided (e.g., built-in or locally controlled). The PN sequences must match to permit the two electrical grids 202 to create the desired electrical charges, for if they do not match, the grids will not create matched phase and amplitude signals that allow the proper effect to occur. The bandwidth of the output signal should match the desired bandwidth of the signal needed to create the plasma. The spread spectrum modulator can create a wide bandwidth signal having essentially the same waveform needed, but with controllable randomness. Thus, when the two signals are correlated, the desired effect will occur, but when the two signals are not correlated, no effect will occur, thereby rendering the compressed plasma device unusable.

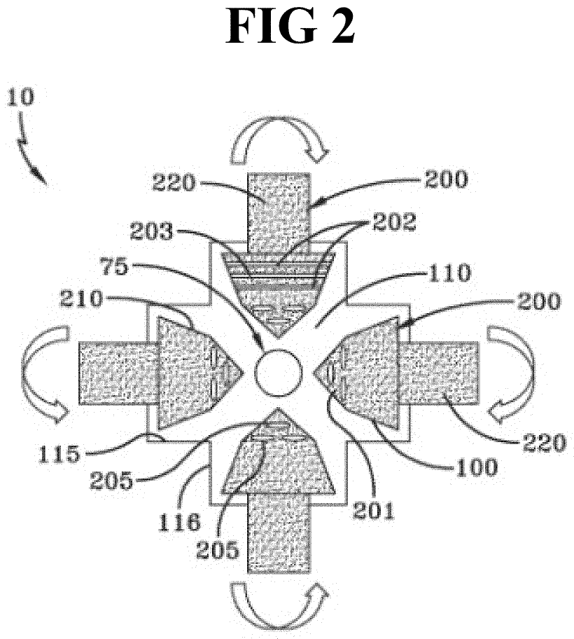

As shown in FIG. 2, the plasma compression fusion device 10 includes a hollow cross-duct 100 and at least two pairs of opposing, smoothly curved-headed, counter-spinning conical structures 200 (which act as dynamic fusors). The hollow cross-duct 100 includes a vacuum chamber 110 disposed within the hollow cross-duct 100. Each opposing, smoothly curved-headed, counter-spinning conical structure 200 has a plurality of orifices 205 and an outer surface 210 which is electrically charged. In combination, the pair of counter-spinning conical structures 200 create a concentrated magnetic energy flux and electromagnetic radiation within the vacuum chamber 110, whereby the concentrated magnetic energy flux compresses a mixture of gases (the fusion fuel) that are injected through the orifices 205 to the vacuum chamber 110 such that a plasma core 75 (also can be referred to as a fusion plasma core, which is a substantially spherical and homogenous collective of electrons and positive ions) is created, and the electromagnetic radiation heats the plasma core 75, while produced magnetic fields confine the plasma core 75 between the counter-spinning conical structures 200, such that when an additional mixture of gases is introduced into the plasma core 75 through the orifices 205 an energy gain is created.

Referring again to FIG. 2, the compressed fusion device includes two pairs of opposing curved-headed counter-spinning conical structures 200. Each conical structure 200, opposing each other in pairs, may have smoothly curved apex sections 201, includes assemblies of electrified grids 202 and toroidal magnetic coils 203. Each toroidal magnetic coil 203 may be disposed between at least two assemblies of electrified grids, arranged within each conical structure 200. The cross-duct 100 may include an inner surface 115 (also has an outer surface 116) surrounding the plasma core 75. The inner surface 115 may be electrically charged and vibrated to prevent plasma particles from impacting the walls of the cross-duct 100 (particularly the inner surface 115) and initiating a plasma quench. The mixture of gases or fusion fuel, preferably Deuterium gas, is introduced into the plasma core 75 through the counter-spinning conical structures 200, namely injected through orifices 205 in the conical structures 200. The conical structures 200 are attached to corresponding hollow shafts 220, through which the mixture of gases or fusion fuel is pressure-fed from a gas reservoir(s) (not shown).

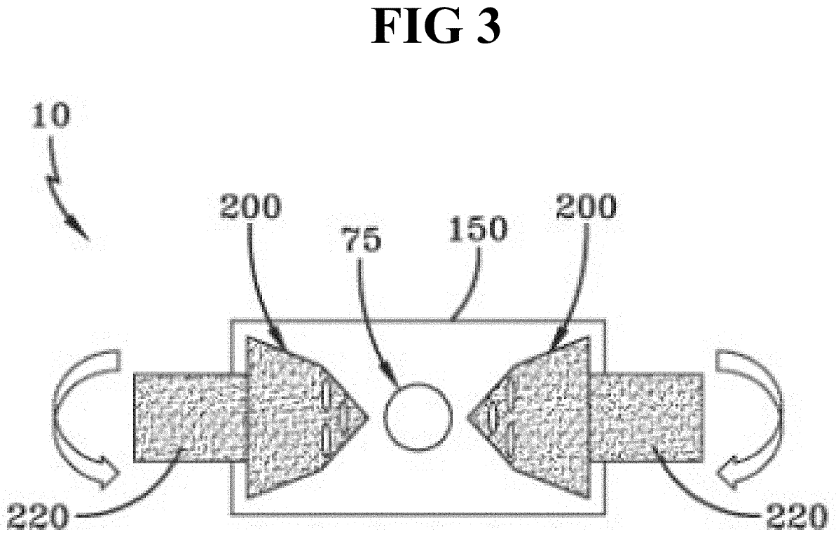

The dynamic fusors can also be dome-like or hemispherical in geometry. Alternatively, as shown in FIG. 3, the dynamic fusors may be conical frustums 230 or truncated cones having an isosceles trapezoidal cross section. The conical frustums 230 also include a plurality of orifices 235, and can include assemblies of electrified grids 202 (at least three) and at least one toroidal magnetic coil 203, arranged within each conical frustum 230. In general, the plurality of orifices 235 can be disposed within the electrified grids 202. As with all other embodiments of the dynamic fusor, each conical frustum 230 may have an outer surface that is electrically charged. Each toroidal magnetic coil 203 must be disposed between two electrified grids 202. The electrical grids 202 are used to ionize the Deuterium gas (or other fusion fuel in gaseous form). Without the matching waveforms driving these grids ionization cannot occur in the desired manner.

The direction of the dynamic fusors 200,230 or dynamic fusor spin is such that the generated magnetic flux always points towards the plasma core 75. The dynamic fusors 200, 230 can act as particle accelerators for electrons which are closely bound to the magnetic field lines of the toroidal coil 203, as well as to the magnetic field lines of the dynamic fusors 200, 230, once they exit each dynamic fusors 200, 230. These electrons are electrostatically accelerated through a set of two electrical grids 202 (one grid may be a positive voltage charge grid and another negative voltage charged grid, both having the ability to switch electrical charge) exhibiting a potential difference into the plasma core 75, forming a deep (high energy) negative potential well. This negative potential well greatly accelerates the positively charged ions toward it, and as the ions keep recirculating around the well, they undergo fusion. Without proper matching waveforms on each grid, this cannot occur. A high temperature, high pressure plasma core 75 results from the impingement of gas dynamic vortical plumes, which exhibit high viscous heating, as well as the intense collisions of electrons and positively charged ions which make up these plumes. In order to heat the plasma core 75 at the extreme temperatures that fusion requires, the electrically charged dynamic fusors 200, 230 generate high electromagnetic radiation by virtue of their accelerating spin. Each dynamic fusor 200, 230 is mounted to a corresponding hollow shaft 220 (which can also be referred as a fusion fuel conduit), which is coupled to a variable power DC induction motor (not shown) and a gas reservoir (not shown), and can be accelerated-decelerated-accelerated in spin, via a digital controller (not shown). The digital controller can also be keyed with the same PN sequence to prevent improper operation.

What is claimed is:

1. A plasma compression fusion device comprising:
a hollow linear-duct having a vacuum chamber disposed within the hollow linear-duct;
one pair of opposing, smoothly curved-headed, counter-spinning conical structures disposed within the hollow linear-duct, each counter-spinning conical structure having a plurality of orifices and an outer surface which is electrically charged, and in combination the pair create a concentrated magnetic energy flux and electromagnetic radiation within the vacuum chamber, whereby the concentrated magnetic energy flux compresses a mixture of gases that are injected through the orifices to the vacuum chamber such that a plasma core is created, and the electromagnetic radiation heats the plasma core, while produced magnetic fields confine the plasma core between the counter-spinning conical structures, such that when an additional mixture of gases is introduced into the plasma core through the orifices, an energy gain is created;
a first spread spectrum modulator receiving a first pseudorandom sequence and being coupled to the electrically charged outer surface and driving the outer surface with a first electrical signal;
a second spread spectrum modulator receiving a second pseudorandom sequence and being coupled to the plurality of orifices and driving the plurality of orifices with a second electrical signal being electrically negative with respect to the first electrical signal; and
whereby if the first pseudorandom signal matches the second pseudorandom signal, said first electrical signal matches said second electrical signal in phase and amplitude but with opposite charge, thereby enabling said energy gain to be created only if the two pseudorandom sequences match.

2. A plasma compression fusion device comprising:
a hollow cross-duct having a vacuum chamber disposed within the hollow cross-duct;
at least two pairs of opposing, smoothly curved-headed, counter-spinning conical structures disposed within the hollow cross-duct, each counter-spinning conical structure having a plurality of orifices and an outer surface which is electrically charged, and in combination all the pairs create a concentrated magnetic energy flux and electromagnetic radiation within the vacuum chamber, whereby the concentrated magnetic energy flux compresses a mixture of gases that are injected through the orifices the vacuum chamber such that a plasma core is created, and the electromagnetic radiation heats the plasma core, while produced magnetic fields confine the plasma core between the counter-spinning conical structures, such that when an additional mixture of gases is introduced into the plasma core through the orifices, an energy gain is created;
a first spread spectrum modulator receiving a first pseudorandom sequence and being coupled to the electrically charged outer surface and driving the outer surface with a first electrical signal;
a second spread spectrum modulator receiving a second pseudorandom sequence and being coupled to the plurality of orifices and driving the plurality of orifices with a second electrical signal being electrically negative with respect to the first electrical signal; and
whereby if the first pseudorandom signal matches the second pseudorandom signal, said first electrical signal matches said second electrical signal in phase and amplitude but with opposite charge, thereby enabling said energy gain to be created only if the two pseudorandom sequences match.

3. A plasma compression fusion device comprising:
a hollow cross-duct having a vacuum chamber disposed within the hollow cross-duct;
at least two pairs of conical frustums disposed within the hollow cross-duct, each conical frustum having a plurality of orifices and an outer surface which is electrically charged, and in combination all the pairs create a concentrated magnetic energy flux and electromagnetic radiation within the vacuum chamber, whereby the concentrated magnetic energy flux compresses a mixture of gases that are injected through the orifices to the vacuum chamber such that a plasma core created, and the electromagnetic radiation heats the plasma core, while produced magnetic fields confine the plasma core between conical frustums, such that when an additional mixture of gases is introduced into the plasma core through the orifices, an energy gain is created;
a first spread spectrum modulator receiving a first pseudorandom sequence and being coupled to the electrically charged outer surface and driving the outer surface with a first electrical signal;
a second spread spectrum modulator receiving a second pseudorandom sequence and being coupled to the plurality of orifices and driving the plurality of orifices with a second electrical signal being electrically negative with respect to the first electrical signal; and
whereby if the first pseudorandom signal matches the second pseudorandom signal, said first electrical signal matches said second electrical signal in phase and amplitude but with opposite charge, thereby enabling said energy gain to be created only if the two pseudorandom sequences match.
